(19) United States
(12) Patent Application Publication
(10) Pub. No.: US 2012/0115012 A1
(43) Pub. Date: May 10, 2012

(54) Rechargeable battery installation mechanism

(76) Inventors: Shih-Hui Chen, Luchu Hsiang (TW); Chin-Tien Lin, Luchu Hsiang (TW); Tung-Han Kao, Luchu Hsiang (TW)

(21) Appl. No.: 12/940,483

(22) Filed: Nov. 5, 2010

(51) Int. Cl. H01M 10/02

(52) U.S. Cl. 429/159

(57) ABSTRACT

A rechargeable battery installation mechanism is provided and includes a box body installed with a plurality of rechargeable batteries. A circuit of cascading or parallel connecting each rechargeable battery is disposed between each rechargeable battery and an upper cover or a lower cover of the box body and is combined to each rechargeable battery while waiting for use. The mechanism utilizing the feature of rechargeable battery is that the charging of a single rechargeable battery or parallel connected rechargeable batteries is easily controlled. The rechargeable batteries then are cascaded or connected in parallel while in use. It does not need to apply a charging protection board, and the optimum circulation life of the rechargeable battery can be obtained under conditions of fully charging all rechargeable batteries and having the identical voltages.

### BACKGROUND OF THE INVENTION

1. Field of the Invention

The present invention relates to a rechargeable battery installation mechanism, and more particularly to a rechargeable battery installation mechanism capable of allowing a rechargeable battery to have more flexibility and convenient installation in application and reducing the cost of the rechargeable battery, extending the service life of the rechargeable battery and obtaining the optimum performance.

2. Description of the Related Art

A lithum cell has been demonstrated to play an excellent role of electronic device in many applications and is applied to portable consumer electronics such as mobile phones, personal digital assistants (PDA), hand-held power tools or laptop computers. Moreover, since environmental protection consciousness rises due to global warming, petrochemical energy power may be replaced with electric power to achieve energy saving and carbon reduction. The safety of a battery module cascaded by each lithum cell has also been greatly improved to satisfy a normal demand with respect to electric motor vehicles.

Generally speaking, a battery has a constant output voltage. While using electric bicycles, electric motorcycles, golf buggies and hybrid power automobiles, its rated voltage and power demand are different. Positive and negative poles of several batteries are cascaded to form a battery set having output voltage of many times. Alternatively, positive poles of several batteries are connected, and negative poles of the batteries are also connected to form a parallel connection. The outputted electric capacity is larger than original, wherein when several batteries are cascaded or connected in parallel, nickel pieces are generally taken as a structure of electrically connecting each battery.

A conventional multi-cascaded or multi-parallel connected high power battery set includes many batteries and a protection circuit board. Each battery is mutully soldered by utilizing nickel pieces so as to form a battery module that is cascaded or connected in parallel. The battery module then is soldered with the protection circuit board to assemble a high power battery set. However, the conventional assembly has the following defects:
1. When each battery is mutually soldered and assembled, each battery must be soldered one by one to consume time and cost. If mistakes caused by testing the multi-cascaded or multi-parallel connected high power battery set occur, operators must dismount the circuit board from the battery module to really consume man power and greatly influence the efficiency.
2. The multi-cascaded or multi-parallel connected high power battery set is fixedly assembled. If a single or a portion of batteries is damaged, the whole set must be placed to incrase the utilization cost for users.
3. When the multi-cascaded or multi-parallel connected high power battery set is charged, voltage or electric capacity obtained by charged batteries is different due to each battery mutually cascaded or connected in parallel. Consequently, some batteries are not fully charged to reduce the utilization efficiency of the multi-cascaded or multi-parallel connected high power battery set.

### SUMMARY OF THE INVENTION

In view of the shortcomings of the prior art, the inventor(s) of the present invention based on years of experience in the related industry to conduct extensive researches and experiments, and finally developed a rechargeable battery installation mechanism capable of allowing a rechargeable battery to have more flexibility and convenient installation in application and reducing the cost of the rechargeable battery, extending the service life of the rechargeable battery and obtaining the optimum performance for the rechargeable battery.

The rechargeable battery installation mechanism is provided and mainly comprises a box body installed with a plurality of rechargeable batteries. A circuit of cascading or parallel connecting each rechargeable battery is disposed between each rechargeable battery and an upper cover or a lower cover of the box body and is combined to each rechargeable battery while waiting for use. The mechanism utilizing the feature of rechargeable battery is that the charging of a single rechargeable battery or parallel connected rechargeable batteries is easily controlled. The rechargeable batteries then are cascaded or connected in parallel while in use. It does not need to apply a charging protection board, and the optimum circulation life of the rechargeable battery can be obtained under conditions of fully charging all rechargeable batteries and having the identical voltages.

### BRIEF DESCRIPTION OF THE DRAWINGS

FIG. 1 is a decomposition drawing of a structure of a rechargeable battery installation mechanism according to a first embodiment of the present invention;

FIG. 2 is a schematic diamgram of a structure of a rechargeable battery installation mechanism according to a first embodiment of the present invention;

FIG. 3 is a schematic diamgram of a loop of a rechargeable battery installation mechanism according to the present invention;

FIG. 4 is a decomposition drawing of a structure of a rechargeable battery installation mechanism according to a second embodiment of the present invention;

FIG. 5 is a decomposition drawing of a structure of a rechargeable battery installation mechanism according to a third embodiment of the present invention; and

FIG. 6 is a schematic diagram of a structure of a rechargeable battery installation mechanism according to a third embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

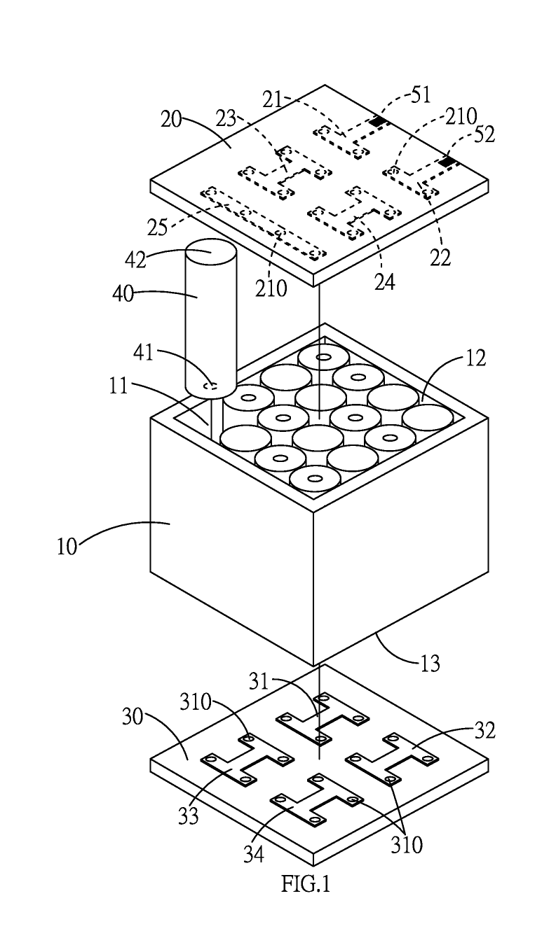

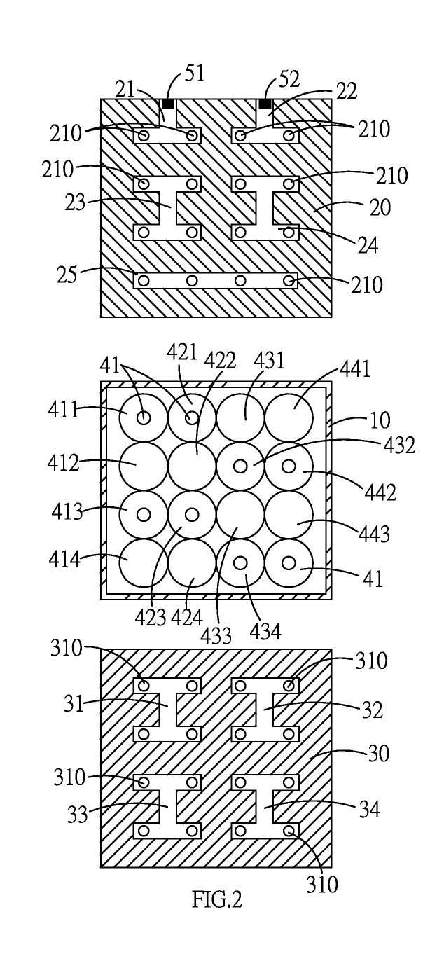

With reference to FIG. 1 and FIG. 2 for a structural decomposition drawing and a block diagram of a rechargeable battery installation mechanism in accordance with a first embodiment of the invention are depicted. The rechargeable battery installation mechanism comprises a box body 10, an upper cover 20, a lower cover 30 and a plurality of rechargeable batteries 40. The box body 10 is provided with a containing space 11. The containing space 11 is provided with an upper opening 12 and a lower opening 13.

The upper cover 20 is relatively disposed to the upper opening 12 of the containing space 11. The upper cover 20 has a first set of connecting sheet disposed toward a side of the containing space 11. As shown in the embodiment of the figure, the first set of connecting sheet has five connecting sheets (the first connecting sheet 21, the second connecting sheet 22, the third connecting sheet 23, the fourth connecting sheet 24 and the fifth connecting sheet 25). Each connecting sheet 21, 22, 23, 24, 25 is provided with at least two contact points 210 respectively.

The lower cover 30 is relatively disposed under a lower opening 13 of the containing space 11. A side of the lower cover 30 has a second set of connecting sheet toward the containing space 11. The embodiment shown in the figure, the second set of connecting sheet has four connecting sheets (the first connecting sheet 31, the second connecting sheet 32, the third connecting sheet 33 and the fourth connecting sheet 34). Each connecting sheet 31, 32, 33, 34 is respectively provided with at least two contact points 310. Each connecting sheet on the lower cover 20 and the upper cover 30 can be a nickel sheet or a spring. Each contact point 210, 310 can be a connector, a metal elastic piece, a spring pin or an elastic piece.

The plurality of rechargeable batteries 40 is installed in the containing space 11. A positive pole 41 and a negative pole 42 of each rechargeable battery 30 can be connected to the connecting sheets so that the rechargeable batteries 40 are cascaded or connected in parallel.

Sixteen rechargeable batteries 40 are contained in the containing space 11 of the box body. Each rechargeable battery 40 can be a circular tubular battery, and each rechargeable battery 40 is arranged as a four times four matrix, wherein each rechargeable battery in adjacent first and second rows or adjacent third and fourth rows is arranged with the same direction at the horizontal direction and is arranged with an opposite direction at the vertical direction. Each rechargeable battery of adjacent second and third rows is arranged with the opposite direction at the horizontal direction. Namely, positive poles of the first rechargeable batteries 411, 421 of the first row and the second row are upward. Negative poles of the second rechargeable batteries 412, 422 of the first row and the second row are upward, and the negative poles of first rechargeable batteries 431, 441 of the third row and the fourth row are upward.

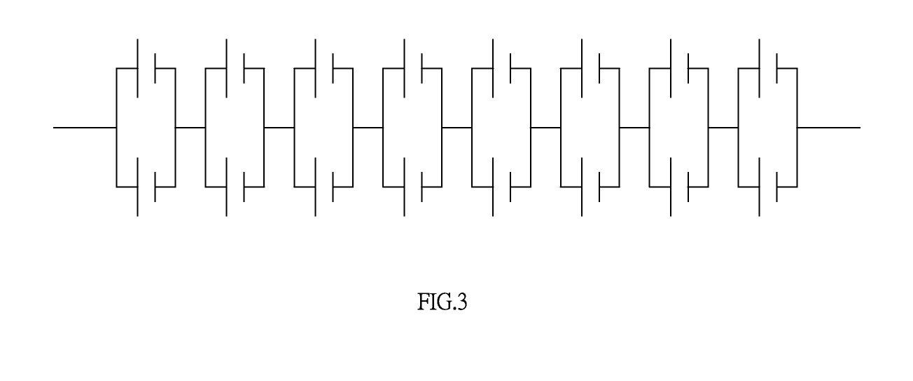

The contact points 210 of the first connecting sheet 21 of the upper cover are in contact with the first rechargeable batteries 411, 421 in the first row and the second row. The contact points 210 of the second connecting sheet 22 are in contact with the first rechargeable batteries 431, 441 in the third row and the fourth row. The contact points 210 of the third connecting sheet 23 are in contact with the second rechargeable batteries 412, 422 and the third rechargeable batteries 413, 423 in the first row and the second row. The contact points 210 of the fourth connecting sheet 24 are in contact with the second rechargeable batteries 432, 442 and the third rechargeable batteries 433, 443 in the third row and the fourth row. The contact points 210 of the fifth connecting sheet 25 are in contact with the fourth rechargeable batteries 414, 424, 434, 444 in the first row, the second row, the third row and the fourth row. The contact points 310 of the first connecting sheet 31 of the lower cover are in contact with the first rechargeable batteries 411, 421 and the second rechargeable batteries 412, 422 in the first row and the second row. The contact points 310 of the second connecting sheet 32 are in contact with the first rechargeable batteries 431, 441 and the second rechargeable batteries 432, 442 in the third row and the fourth row. The contact points 310 of the third connecting sheet 33 are in contact with the third rechargeable batteries 413, 423 and the fourth rechargeable batteries 414, 424 in the first row and the second row. The contact points 310 of the fourth connecting sheet 34 are in contact with the third rechargeable batteries 433, 443 and the fourth rechargeable batteries 434, 444 in the third row and the fourth row. Each rechargeable battery 40 inside the box body 10 is formed with eight strings of two parallel connected circuits through the disposition of the connecting sheets in the first embodiment as shown in FIG. 3. A first external junction point 51 and a second external junction point 52 are further disposed to the upper cover 20 as shown in FIG. 1 and FIG. 2 and respectively connected to the first connecting sheet 21 and the second connecting sheet 22.

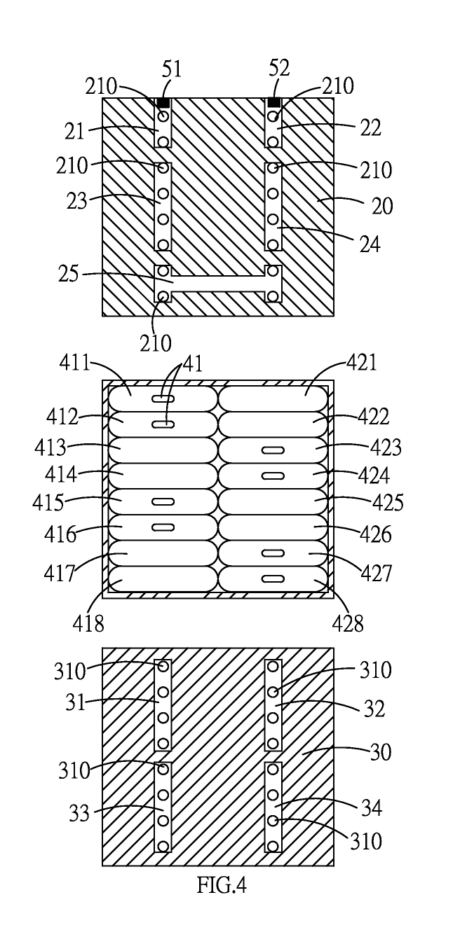

In a second embodiment shown in FIG. 4, each rechargeable battery 40 can be a rectangular type battery, and each rechargeable battery 40 is arranged an eight times two matrix, wherein each rechargeable battery in adjacent first and second rows is arranged with the same direction at a vertical direction based upon a set of a pair of rechargeable batteries. The rechargeable batteries between djacent sets are arranged with the opposite direction. Namely, positive poles of the first rechargeable battery 411 and the second rechargeable battery 412 in the first row are upward. Negative poles of the first rechargeable battery 421 and the second rechargeable battery 422 in the second row, and negative poles of the third rechargeable battery 413 and the fourth rechargeable battery 414 in the first row are upward.

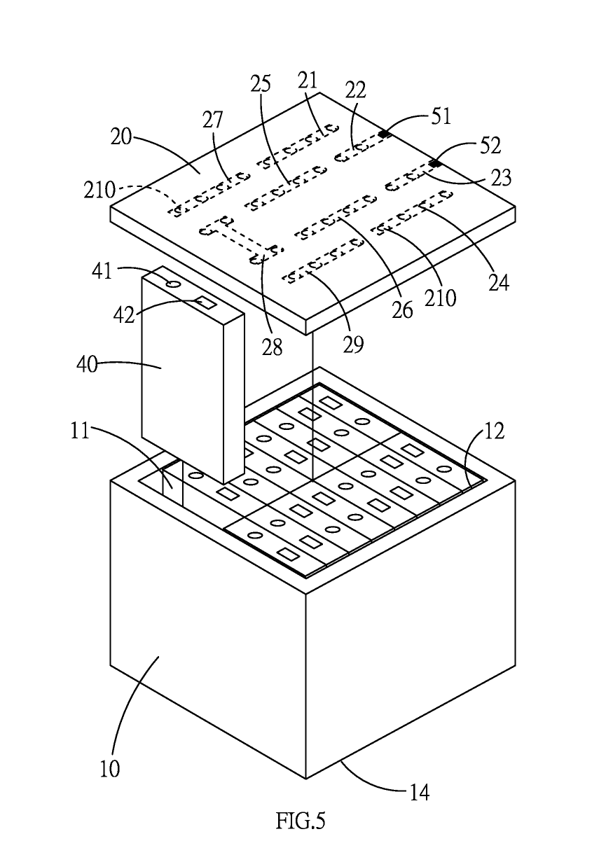

The contact points 210 of the first connecting sheet 21 of the upper cover are in contact with the first rechargeable battery 411 and the second rechargeable battery 412 in the first row. The contact points 210 of the second connecting sheet 22 are in contact with the first rechargeable battery 421 and the second rechargeable battery 422 in the second row. The contact points 210 of the third connecting sheet 23 are in contact with the third rechargeable battery 413, the fourth rechargeable battery 414, the fifth rechargeable battery 415 and the sixth rechargeable battery 416 in the first row. The contact points 210 of the fourth connecting sheet 24 are in contact with the third rechargeable battery 423, the fourth rechargeable battery 424, the fifth rechargeable battery 425 and the sixth rechargeable battery 426 in the second row. The contact points 210 of the fifth connecting sheet 25 are in contact with the seventh rechargeable batteries 417, 427 and the eighth rechargeable batteries 428, 428 in the first row and the second row. The contact points 310 of the first connecting sheet 31 of the lower cover are in contact with the first rechargeable battery 411, the second rechargeable battery 412, the third rechargeable battery 413 and the fourth rechargeable battery 414 in the first row. The contact points 310 of the second connecting sheet 32 are in contact with the first rechargeable battery 421, the second rechargeable battery 422, the third rechargeable battery 423 and the fourth rechargeable battery 424 in the second row. The contact points 310 of the third connecting sheet 33 are in contact with the fifth rechargeable battery 415, the sixth rechargeable battery 416, the seventh rechargeable battery 417 and the eighth rechargeable battery 418 in the first row. The contact points 310 of the fourth connecting sheet 34 are in contact with the fifth rechargeable battery 425, the sixth rechargeable battery 426, the seventh rechargeable battery 427 and the eighth rechargeable battery 428 in the second row. Each rechargeable battery inside the box body 10 is formed with eight strings of two parallel connected circuits through the disposition of the connecting sheets in the second embodiment as shown in FIG. 4. A first external junction point 51 and a second external junction point 52 are further disposed to the upper cover 20 and connected to the first connecting sheet 21 and the second connecting sheet 22 as shown in FIG. 5.

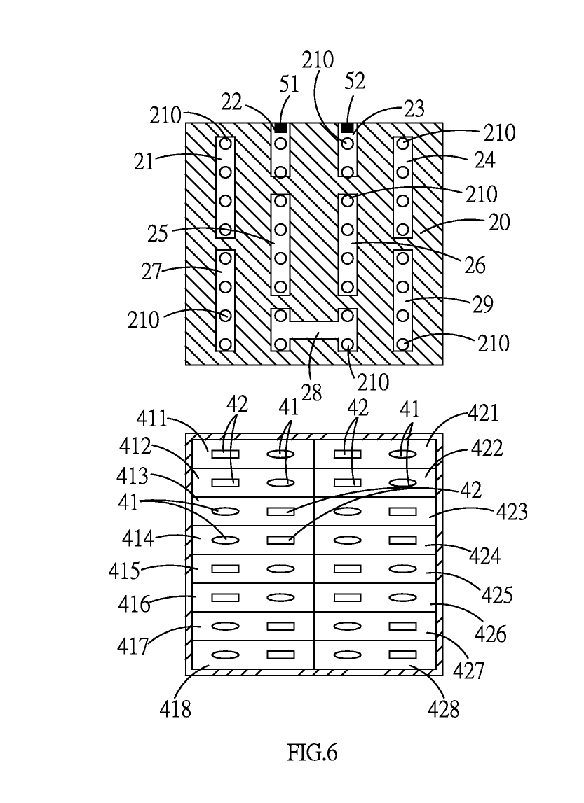

In a third embodiment shown in FIG. 5 and FIG. 6, the rechargeable battery installation mechanism comprises a box body 10, an upper cover 20 and a plurality of rechargeable batteries 40, wherein the box body 10 is also provided with a containing space 11. The containing space also has an upper opening 12 and a lower bottom surface 14. Each rechargeable battery 40 is installed in the containing space 11. The upper cover 20 is relatively disposed to the upper opening 12 of the containing space. A side of the upper cover 20 is provided with a plurality of connecting sheets that is toward the containing space. In the embodiment, the upper cover 20 is provided with nine connecting sheets (the first connecting sheet 21, the second connecting sheet 22, the third connecting sheet 23, the fourth connecting sheet 24, the fifth connecting sheet 25, the sixth connecting sheet 26, the seventh connecting sheet 27, the eighth connecting sheet 28 and the nineth connecting sheet 29). Each connecting sheet 21, 22, 23, 24, 25, 26, 27, 28, 29 is provided with at least two contact points 210.

Sixteen rechargeable batteries 40 are contained in the containing space 11 of the box body. Each rechargeable battery 40 can be lithium ion polymer cell. A positive pole 41 and a negative pole 42 of each rechargeable battery 40 are disposed to two ends at the same surface, and each rechargeable battery is arranged as an eight times two matrix. Each rechargeable battery is arranged with the same direction at the vertical direction based upon a set of a pair of rechargeable batteries. Rechargeable batteries between adjacent sets are arranged with the opposite direction. Namely, negative poles 42 of the first rechargeable battery 411 and the second rechargeable battery 412 in the first row are located at a left side, and positive poles 41 of the first rechargeable battery 411 and the second rechargeable battery 412 in the first row are located at a right side. Negative poles 42 of the first rechargeable battery 421 and the second rechargeable battery 422 in the second row are upward, and negative poles 42 of the third rechargeable battery 413 and the fourth rechargeable battery 414 are upward.

The contact points 210 of the first connecting sheet 21 of the upper cover are in contact with the negative poles 42 of the first rechargeable battery 411 and the second rechargeable battery 412 and positive poles 41 of the third rechargeable battery 413 and the fourth rechargeable battery 414 in the first row. The contact points 210 of the second connecting sheet 22 are in contact with the positive poles 41 of the first rechargeable battery 421 and the second rechargeable battery 422 in the first row. The contact points 210 of the third connecting sheet 23 are in contact with the negative poles 42 of the first rechargeable battery 421 and the second rechargeable battery 422 in the second row. The contact points 210 of the fourth connecting sheet 24 are in contact with the positive poles 41 of the first rechargeable battery 421 and the second rechargeable battery 422 and the negative poles 32 of the third rechargeable battery 423 and the fourth rechargeable battery 424 in the second row. The contact points 210 of the fifth connecting sheet 25 are in contact with the negative poles 42 of the third rechargeable battery 413 and the fourth rechargeable battery 414 and the positive poles 41 of the fifth rechargeable battery 415 and the sixth rechargeable battery 416 in the first row. The contact points 210 of the sixth connecting sheet 26 are in contact with the positive poles 41 of the third rechargeable battery 423 and the fourth rechargeable battery 424 and the negative poles 42 of the fifth rechargeable battery 425 and the sixth rechargeable battery 426. The contact points 210 of the seventh connecting sheet 27 are in contact with the negative poles 42 of the fifth rechargeable battery 415 and the sixth rechargeable battery 416 and the positive poles 41 of the seventh rechargeable battery 417 and the eighth rechargeable battery 418 in the first row. The contact points 210 of the eighth connecting sheet 28 are in contact with the negative poles 42 of the seventh rechargeable battery 417 and the eighth rechargeable battery 418 in the first row and the positive poles 41 of the seventh rechargeable battery 427 and the eighth rechargeable battery 428 in the second row. The contact points 210 of the nineth connecting sheet 29 are in contact with the negative poles 41 of the fifth rechargeable battery 425 and the sixth rechargeable battery 426 and the negative poles 42 of the seventh rechargeable battery 427 and the eighth rechargeable battery 428 in the second row. Each rechargeable battery inside the box body is formed with eight strings of two parallel connected circuits through the disposition of the connecting sheet in the third embodiment. A first external junction point 51 and a second external junction point 52 are disposed to the upper cover 20 and respectively connected to the second connecting sheet 22 and the third connecting sheet 23.

In the foregoing embodiments, the first set of connecting sheet and the second set of connecting sheet can be integrally disposed to the upper cover and the lower cover or separately disposed to the upper cover and the lower cover.

The structure shown in the invention has the following advantages by comparing with the conventional installation structure:
1. The connection circuit between rechargeable batteries is additionally manufactured at the upper cover or the lower cover of the box body without using soldering. The processing is simple, and the processing cost is greatly reduced.
2. When the rechargeable battery installation mechanism is charging, the charging equipment is utilized to charge each rechargeable battery one by one. Alternatively, the charging is performed by utilizing parallel connection to allow each rechargeable battery having the same voltage or electric capacity after charging each rechargeable battery. The rechargeable batteries have better application performance, and the service life of the rechargeable batteries can be ensured. The rechargeable circuit board can be disposed in the charging equipment so that the rechargeable battery installation mechanism does not need to equip with the rechargeable circuit board.
3. The connection circuit can be separated with the rechargeable battery without using the soldering. When a single rechargeable battery or a portion of rechargeable batteries is damaged, the damaged rechargeable batteries could be replaced, and there is no need to discard the whole set of the mechanism.
4. A specific voltage or electric capacity is formed by different connection circuits to apply in different electronic products. The rechargeable battery installation mechanism of the invention can be connected the electronic product through the first and second external junction points while in discharging process.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A rechargeable battery installation mechanism comprising:
a box body having a containing space that is provided with an upper opening and a lower opening;
an upper cover relatively disposed to the upper opening of the containing space;
a lower cover relatively disposed to the lower opening of the containing space;
a first set of connecting sheets and a second set of connecting sheets respectively having a plurality of connecting sheets, the first set of connecting sheets disposed between the upper cover and the containing space, the second set of connecting sheets disposed between the lower cover and the containing space; and
a plurality of rechargeable batteries installed in the containing space, a positive pole and a negative pole of each rechargeable battery connected to the connecting sheets so that the rechargeable batteries are cascaded or connected in parallel.

2. The rechargeable battery installation mechanism as recited in claim 1, wherein the connecting sheet is a nickel piece or a spring.

3. The rechargeable battery installation mechanism as recited in claim 1, wherein each connecting sheet is further provided with contact points, and each contact point is a connector, a metal elastic piece, a spring pin or an elastic piece.

4. The rechargeable battery installation mechanism as recited in claim 1, wherein sixteen rechargeable batteries are contained in the containing space of the box body.

5. The rechargeable battery installation mechanism as recited in claim 4, wherein each rechargeable battery is a circular tubular battery, and each rechargeable battery is arranged as a four times four matrix, and each rechargeable battery in adjacent first and second rows or a third or fourth rows is arranged with a same direction at a horizontal direction or arranged with an opposite direction at a vertical direction, and each rechargeable battery in adjacent second and third rows is arranged with the opposite direction at the horizontal direction.

6. The rechargeable battery installation mechanism as recited in claim 5, wherein the first set of connecting sheets is provided with five connecting sheets, the first connecting sheet is in contact with a first rechargeable battery in a first row and a second row, and the second connecting sheet is in contact with the first rechargeable battery in a third row and a fourth row, and the third connecting sheet is in contact with a second rechargeable battery and a third rechargeable battery in the first row and the second row, and the fourth connecting sheet is in contact with the second rechargeable battery and the third rechargeable battery in the third row and the fourth row, and the fifth connecting sheet is in contact with a fourth rechargeable battery in the first row, the second row, the third row and the fourth row, and the second set of connecting sheets is provided with four connecting sheets, and the first connecting sheet is in contact with a first rechargeable battery and a second rechargeable battery in the first row and the second row, and the second connecting sheet is in contact with the first rechargeable battery and the second rechargeable battery in the third row and the fourth row, and the third connecting sheet is in contact with the third rechargeable battery and the fourth rechargeable battery in the first row and the second row, and the fourth connecting sheet is in contact with the third rechargeable battery and the fourth rechargeable battery in the third row and the fourth row.

7. The rechargeable battery installation mechanism as recited in claim 6, wherein a first external junction point and a second external junction point are further disposed to the upper cover and respectively connected to the first connecting sheet and the second connecting sheet.

8. The rechargeable battery installation mechanism as recited in claim 4, wherein each rechargeable battery is a rectangular rechargeable battery, and each rechargeable battery is arranged as an eight times two matrix, and each rechargeable battery is arranged with a same direction at the vertical direction based upon a set of a pair of rechargeable batteries, and the rechargeable batteries between djacent sets are arranged with the opposite direction.

9. The rechargeable battery installation mechanism as recited in claim 8, wherein the first set of connecting sheet is provided with five connecting sheets, and the first connecting sheet is in contact with a first rechargeable battery and a second rechargeable battery in a first row, and the second connecting sheet is in contact with the first rechargeable battery and the second rechargeable battery in a second row, and the third connecting sheet is in contact with a third rechargeable battery, a fourth rechargeable battery, a fifth rechargeable battery and a sixth rechargeable battery in the first row, and the fourth connecting sheet is in contact with the third rechargeable battery, the fourth rechargeable battery, the fifth rechargeable battery and the sixth rechargeable battery in the second row, and the fifth connecting sheet is in contact with a seventh rechargeable battery and an eighth rechargeable battery in the first row and the second row, and the second set of connecting sheet is provided with four connecting sheets, and the first connecting sheet is in contact with the first rechargeable battery, the second rechargeable battery, the third rechargeable battery and the fourth rechargeable battery in the first row, and the second connecting sheet is in contact with the first rechargeable battery, the second rechargeable battery, the third rechargeable battery and the fourth rechargeable battery in the second row, and the third connecting sheet is in contact with the fifth rechargeable battery, the sixth rechargeable battery, the seventh rechargeable battery and the eighth rechargeable battery in the first row, and the fourth connecting sheet is in contact with the fifth rechargeable battery, the sixth rechargeable battery, the seventh rechargeable battery and the eighth rechargeable battery in the second row.

10. The rechargeable battery installation mechanism as recited in claim 9, wherein a first external junction point and a second external junction point are disposed to the upper cover and respectively connected to the first connecting sheet and the second connecting sheet.

11. The rechargeable battery installation mechanism as recited in claim 1, wherein the first set of connecting sheet and the second set of connecting sheet are integrally disposed to the upper cover and the lower cover.

12. A rechargeable battery installation mechanism comprising:
a box body having a containing space that is provided with an upper opening and a lower bottom surface;
an upper cover relatively disposed to the upper opening of the containing space;
a first set of connecting sheet having a plurality of connecting sheets, the first set of connecting sheet disposed between the upper cover and the containing space; and
a plurality of rechargeable batteries installed in the containing space, a positive pole and a negative pole of each rechargeable battery connected to the connecting sheet so that the rechargeable batteries are cascaded or connected in parallel.

13. The rechargeable battery installation mechanism as recited in claim 12, wherein the connecting sheet is a nickel piece or a spring.

14. The rechargeable battery installation mechanism as recited in claim 12, wherein each connecting sheet is further provided with contact points, and each contact point is a connector, a metal elastic piece, a spring pin or an elastic piece.

15. The rechargeable battery installation mechanism as recited in claim 12, wherein sixteen rechargeable batteries are contained in the containing space of the box body, each rechargeable battery is a lithum ion polymer cell, and the positive pole and the negative pole of the rechargeable battery are disposed to two ends at a same surface, and each rechargeable battery is arranged as an eight times two matrix, and each rechargeable battery is arranged with a same direction at a vertical direction based upon a set of a pair of rechargeable batteries, and the rechargeable batteries between adjacent sets are arranged with an opposite direction.

16. The rechargeable battery installation mechanism as recited in claim 15, wherein the first set of connecting sheet is provided with nine connecting sheets, and the first connecting sheet is in contact with negative poles of a first rechargeable battery and a second rechargeable battery and positive poles of a third rechargeable battery and a fourth rechargeable battery in a first row, and the second connecting sheet is in contact with the positive poles of the first rechargeable battery and the second rechargeable battery in the first row, and the third connecting sheet is in contact with the negative poles of the first rechargeable battery and the second rechargeable battery in a second row, and the fourth connecting sheet is in contact with the positive poles of the first rechargeable battery and the second rechargeable battery and the negative poles of a third rechargeable battery and a fourth rechargeable battery in the second row, and the fifth connecting sheet is in contact with the negative poles of the third rechargeable battery and the fourth rechargeable battery and the positive poles of a fifth rechargeable battery and a sixth rechargeable battery in the first row, and the sixth connecting sheet is in contact with the positive poles of the third rechargeable battery and the fourth rechargeable battery and the negative poles of the fifth rechargeable battery and the sixth rechargeable battery in the second row, and the seventh connecting sheet is in contact with the negative poles of the fifth rechargeable battery and the sixth rechargeable battery and the positive poles of a seventh rechargeable battery and an eighth rechargeable battery in the first row, and the eighth connecting sheet is in contact with the negative poles of the seventh rechargeable battery and the eighth rechargeable battery in the first row and the positive poles of the seventh rechargeable battery and the eighth rechargeable battery in the second row, and the nienth connecting sheet is in contact with the positive poles of the fifth rechargeable battery and the sixth rechargeable battery and the negative poles of the seventh rechargeable battery and the eighth rechargeable battery in the second row.

17. The rechargeable battery installation mechanism as recited in claim 16, wherein a first external junction point and a second external junction point are further disposed to the upper cover and respectively connected to the second connecting sheet and the third connecting sheet.

18. The rechargeable battery installation mechanism as recited in claim 12, wherein the first set of connecting sheet is disposed to the upper cover.
